(19) United States
(12) Patent Application Publication
(10) Pub. No.: US 2026/0172513 A1
(43) Pub. Date: Jun. 18, 2026

(54) IMAGE READING APPARATUS

(71) Applicant: SEIKO EPSON CORPORATION, Tokyo (JP)

(72) Inventors: Yuhei HAMADA, SHIOJIRI-SHI (JP); Tokujiro OKUNO, KITAKYUSHU-SHI (JP)

(21) Appl. No.: 19/421,124

(22) Filed: Dec. 16, 2025

(30) Foreign Application Priority Data
Dec. 17, 2024 (JP) 2024-220585
Mar. 4, 2025 (JP) 2025-033540

(51) Int. Cl. H04N 1/00; H04N 1/44

(52) U.S. Cl. CPC H04N 1/00543; H04N 1/00533; H04N 1/00551; H04N 1/00557; H04N 1/00591; H04N 1/00633; H04N 1/4473

(57) ABSTRACT

An image reading apparatus 1 includes: a scanner unit 3 having a receiving port 5 and a discharge port 6 for a medium 2 and configured to read an image on the medium received and conveyed from the receiving port; and a container 4 to which the scanner unit is to be attached internally. The container includes an accommodation unit 8 that accommodates the medium to be discharged from the scanner unit, and an entry port 9 that communicates with the receiving port and allows the medium to enter. The scanner unit is switchable between an exposed state in which the scanner unit is exposed to an outside of the container and a non-exposed state in which the scanner unit is inside the container.

The present application is based on, and claims priority from JP Application Serial Number 2024-220585, filed Dec. 17, 2024, and JP Application Serial Number 2025-033540, filed Mar. 4, 2025, the disclosures of which are hereby incorporated by reference herein in their entirety.

### BACKGROUND

### 1. Technical Field

The present disclosure relates to an image reading apparatus.

### 2. Related Art

An example of the related art of this type of apparatus is disclosed in JP-A-2017-69869.

JP-A-2017-69869 discloses a box-type scanner in which a scanner is accommodated in a case.

JP-A-2017-69869 is an example of the related art.

However, the scanner is accommodated in the case in a fixed state, and thus it is difficult to handle the scanner at the time of maintenance or the like.

### SUMMARY

In order to solve the above problem, an image reading apparatus according to the present disclosure includes: a scanner unit having a receiving port and a discharge port for a medium and configured to read an image on the medium received and conveyed from the receiving port; and a container to which the scanner unit is attached internally, the container includes an accommodation unit that accommodates the medium to be discharged from the scanner unit, and an entry port that communicates with the receiving port and allows the medium to enter, and the scanner unit is switchable between an exposed state in which the scanner unit is exposed to an outside of the container and a non-exposed state in which the scanner unit is inside the container.

An image reading apparatus according to the present disclosure includes: a scanner unit having a receiving port and a discharge port for a medium and configured to read an image on the medium received and conveyed from the receiving port; and a container including an accommodation unit configured to accommodate the medium, and the container includes an installation location portion on an upper surface thereof, the scanner unit being installed in the installation location portion, and a guide path that guides, to the accommodation unit, the medium to be discharged from the discharge port of the scanner unit in a state where the scanner unit is installed in the installation portion.

An image reading apparatus according to the present disclosure includes: a scanner unit having a receiving port and a discharge port for a medium and configured to read an image on the medium received and conveyed from the receiving port; and an attachment portion provided on the scanner unit, and the scanner unit is attachable to an attached portion of another member by the attachment portion.

### BRIEF DESCRIPTION OF THE DRAWINGS

FIG. 1 is a perspective view of an image reading apparatus according to Embodiment 1.

FIG. 2 is a longitudinal cross-sectional view of FIG. 1.

FIG. 3 is a perspective view of a lid portion in an open state according to Embodiment 1.

FIG. 4 is a perspective view of the lid portion in the open state according to Embodiment 1.

FIG. 5 is a perspective view of a modification of Embodiment 1.

FIG. 6 is a longitudinal cross-sectional view of FIG. 5.

FIG. 7 is a perspective view of an image reading apparatus according to Embodiment 2.

FIG. 8 is a perspective view of a lid portion in an open state according to Embodiment 2.

FIG. 9 is a perspective view of an image reading apparatus according to Embodiment 3.

FIG. 10 is a perspective view of a drawing portion in a drawn-out state according to Embodiment 3.

FIG. 11 is a longitudinal cross-sectional view of FIG. 8.

FIG. 12 is a perspective view of an image reading apparatus according to Embodiment 4.

FIG. 13 is a perspective view of the image reading apparatus according to Embodiment 4.

FIG. 14 is a longitudinal cross-sectional view of main parts in FIG. 12.

FIG. 15 is a cross-sectional perspective view of main parts of an image reading apparatus according to Embodiment 5.

FIG. 16 is a cross-sectional side view of main parts of an image reading apparatus according to Embodiment 6.

FIG. 17 is a perspective view of an image reading apparatus according to Embodiment 7.

FIG. 18 is a perspective view and a partially enlarged cross-sectional view of the image reading apparatus according to Embodiment 7.

FIG. 19 is a perspective view of the image reading apparatus attached to another member according to Embodiment 7.

FIG. 20 is a perspective view of the image reading apparatus before being attached to the other member according to Embodiment 7.

FIG. 21 is an enlarged side view of main parts in FIG. 17.

FIG. 22 is a perspective view of the image reading apparatus attached to the other member according to Embodiment 7.

FIG. 23 is a perspective view of an image reading apparatus before being attached to another member according to Embodiment 8.

FIG. 24 is a perspective view of an image reading apparatus attached to the other member according to Embodiment 8.

FIG. 25 is a perspective view of an image reading apparatus attached to another member according to Embodiment 9.

FIG. 26 is a perspective view of the image reading apparatus detached from the other member according to Embodiment 9.

### DESCRIPTION OF EMBODIMENTS

First, the present disclosure will be schematically described.

In order to solve the above problem, an image reading apparatus according to a first aspect of the present disclosure includes: a scanner unit having a receiving port and a discharge port for a medium and configured to read an image on the medium received and conveyed from the receiving port; and a container to which the scanner unit is to be attached internally, the container includes an accommodation unit that accommodates the medium to be discharged from the scanner unit, and an entry port that communicates with the receiving port and allows the medium to enter, and the scanner unit is switchable between an exposed state in which the scanner unit is exposed to an outside of the container and a non-exposed state in which the scanner unit is inside the container.

According to the aspect, the image reading apparatus includes the scanner unit configured to read the image on the medium received and conveyed from the receiving port, and the container to which the scanner unit is to be attached internally. Further, the container includes the accommodation unit that accommodates the medium to be discharged from the scanner unit, and the entry port that communicates with the receiving port and allows the medium to enter. Accordingly, the reading of the image on the medium by the scanner unit and the accommodating of the medium after the reading can be performed in series at the same time, and the usability can be improved.

The scanner unit is switchable between the exposed state in which the scanner unit is exposed to the outside of the container and the non-exposed state in which the scanner unit is inside the container. Accordingly, by switching the scanner unit to the exposed state, access to the scanner unit is facilitated, and maintenance or the like is easily performed.

The image reading apparatus according to a second aspect of the present disclosure is an aspect dependent on the first aspect, in which the container includes a container main body including the accommodation unit, and a lid portion provided on the container main body so as to be capable of switching the accommodation unit between an open state and a closed state, the scanner unit is attached to the lid portion, the entry port is provided in the lid portion, and the scanner unit is brought into the exposed state by bringing the lid portion into the open state.

According to the present aspect, the container includes the lid portion capable of switching the accommodation unit between the open state and the closed state. The scanner unit is attached to the lid portion. The entry port is provided in the lid portion. Then, the scanner unit is brought into the exposed state by bringing the lid portion into the open state. Accordingly, the scanner unit can be easily accessed by bringing the lid portion into the open state.

The image reading apparatus according to a third aspect of the present disclosure is an aspect dependent on the second aspect, in which the lid portion is attached to the container main body so as to be openable and closable by pivoting.

According to the present aspect, the lid portion is attached to the container main body so as to be openable and closable by pivoting. Accordingly, the lid portion can be switched between the open state and the closed state with a simple structure, and thus the scanner unit can be easily accessed.

The image reading apparatus according to a fourth aspect of the present disclosure is an aspect dependent on the second aspect, in which the lid portion is detachably provided on the container main body.

According to the present aspect, the lid portion is detachably provided on the container main body. Accordingly, the scanner unit can be easily accessed by attaching and detaching the lid portion to and from the container main body.

The image reading apparatus according to a fifth aspect of the present disclosure is an aspect dependent on the first aspect, in which the container includes a case having a drawing port, and a drawing portion including the accommodation unit and accommodated in the case so as to be drawable out, the scanner unit is attached to an inside of an operation unit when the drawing portion is drawn out, the entry port is provided in the operation unit, and the scanner unit is brought into the exposed state by drawing out the drawing portion from the case.

According to the present aspect, the container includes the case having the drawing port, and the drawing portion including the accommodation unit and accommodated in the case so as to be drawable out. The scanner unit is attached to the inside of the operation unit when the drawing portion is drawn out. The entry port is provided in the operation unit. Then, the scanner unit is brought into the exposed state by drawing out the drawing portion from the case. Accordingly, the scanner unit can be easily accessed by drawing out the drawing portion from the case.

An image reading apparatus according to a sixth aspect of the present disclosure includes: a scanner unit having a receiving port and a discharge port for a medium and configured to read an image on the medium received and conveyed from the receiving port; and a container including an accommodation unit configured to accommodate the medium, and the container includes an installation location portion on an upper surface thereof, the scanner unit being installed in the installation location portion, and a guide path that guides, to the accommodation unit, the medium to be discharged from the discharge port of the scanner unit in a state where the scanner unit is installed in the installation portion.

The image reading apparatus according to the present aspect includes the scanner unit configured to read the image on the medium received and conveyed from the receiving port, and the container including the accommodation unit configured to accommodate the medium. The container includes the installation location portion on the upper surface thereof, the scanner unit being installed in the installation location portion, and the guide path that guides, to the accommodation unit, the medium to be discharged from the discharge port of the scanner unit in a state where the scanner unit is installed in the installation portion. Accordingly, the reading of the image on the medium by the scanner unit and the accommodating of the medium after the reading can be performed in series at the same time via the guide path, and thus the usability is good. In addition, the scanner unit is installed in the installation location portion located on the upper surface of the container, and thus the access to the scanner unit is facilitated, and the maintenance or the like is easily performed.

The image reading apparatus according to a seventh aspect of the present disclosure is an aspect dependent on the sixth aspect, in which the scanner unit is detachably attached to the installation location portion, and when the scanner unit is installed in the installation location portion, the discharge port is connected to the guide path.

According to the present aspect, the scanner unit is detachably attached to the installation location portion, and when the scanner unit is installed in the installation location portion, the discharge port is connected to the guide path. Accordingly, the scanner unit can be detached from the container. In addition, when the scanner unit is installed in the container, the installation can also be easily performed.

The image reading apparatus according to an eighth aspect of the present disclosure is an aspect dependent on the sixth aspect, in which the receiving port receives the medium from a direction intersecting a vertical direction, the discharge port is located on a rear side when the receiving port is located on a front side, and the guide path is located on the rear side.

The present aspect can also be dependent on the seventh aspect.

According to the present aspect, the receiving port is located on the front side, and a user inserts the medium from a lateral direction rather than from above, and thus it is easy to use. In addition, there is little possibility that a foreign matter falls into the receiving port.

The image reading apparatus according to a ninth aspect of the present disclosure is an aspect dependent on the first aspect, in which the container includes two or more accommodation units including a first accommodation unit and a second accommodation unit as the accommodation units, and a switching unit that switches a discharge destination of the medium to be discharged from the discharge port to each of the two or more accommodation units.

The present aspect can also be dependent on any one of the second to fifth aspects and the seventh and eighth aspects.

According to the present aspect, the container can switch the discharge destination of the medium to be discharged from the discharge port to the first accommodation unit or the second accommodation unit by the switching unit. Accordingly, the medium can be accommodated separately for each type of the medium, and handling of the storage of the medium is facilitated.

The image reading apparatus according to a tenth aspect of the present disclosure is an aspect dependent on the first aspect, further including: a shredder configured to shred the medium downstream of the discharge port in a discharge direction of the medium.

The present aspect can also be dependent on any one of the second to fifth aspects and the seventh to ninth aspects.

According to the present aspect, the image reading apparatus includes: the shredder configured to shred the medium downstream of the discharge port in the discharge direction of the medium. Accordingly, when the medium is to be discarded after the image is read, the medium can be easily discarded by the shredder.

An image reading apparatus according to an eleventh aspect of the present disclosure includes: a scanner unit having a receiving port and a discharge port for a medium, and configured to read an image on the medium received and conveyed from the receiving port and discharge the medium from the discharge port; and an attachment portion provided on the scanner unit, and the scanner unit is attachable to an attached portion of another member by the attachment portion.

According to the present aspect, the scanner unit is provided with the attachment portion. Then, the scanner unit is attachable to the attached portion of the other member by the attachment portion. Accordingly, the attachment to one or more other members via the attachment portion becomes possible, which increases the variation of usage, and improves the usability.

The image reading apparatus according to a twelfth aspect of the present disclosure is an aspect dependent on the eleventh aspect, in which the attachment portion is a hook member, and the hook member is installed at both end portions in an extending direction of the scanner unit or both end portions in a direction intersecting the extending direction.

According to the present aspect, the attachment portion is the hook member. Accordingly, the scanner unit can be attached in a state of being hooked on the attached portion of the other member, and thus the scanner unit can be stably attached to the other member. In addition, a compact design can be achieved for the attachment portion.

The image reading apparatus according to a thirteenth aspect of the present disclosure is an aspect dependent on the eleventh aspect, further including: a base member to which the scanner unit is to be attached, in which the base member includes an entry port that communicates with the receiving port and allows the medium to enter, and the attachment portion is provided on the base member.

According to the present aspect, the image reading apparatus includes: a base member to which the scanner unit is to be attached, and the attachment portion is provided on the base member. Accordingly, the scanner unit is in a state of being attached to the other member via the base member, and thus the stability of the attached state is good.

The base member includes the entry port that communicates with the receiving port and allows the medium to enter. Accordingly, in a state in which the scanner unit is attached to, for example, a container, the scanner unit is surrounded by the container and the base member. Therefore, it is possible to reduce the possibility of damage due to an inadvertent impact or the like.

The image reading apparatus according to a fourteenth aspect of the present disclosure is an aspect dependent on the eleventh aspect, in which the other member is a container having an opening and being capable of accommodating the medium to be discharged from the discharge port, the attached portion is a peripheral edge portion that forms the opening, the attachment portion is a lid that closes the opening, and the lid includes the scanner unit attached thereto and an entry port that communicates with the receiving port and allows the medium to enter.

According to the present aspect, the other member is the container having the opening and being capable of accommodating the medium to be discharged from the discharge port. The attached portion is the peripheral edge portion that forms the opening. The attachment portion is the lid that closes the opening. Further, the lid includes the scanner unit attached thereto and the entry port that communicates with the receiving port and allows the medium to enter.

Accordingly, when the scanner unit is attached to the container, the scanner unit is covered with the lid. Therefore, the scanner unit is in a protected state without being exposed to the outside, and there is little possibility of damage due to an inadvertent impact or the like.

The image reading apparatus according to a fifteenth aspect of the present disclosure is an aspect dependent on the eleventh aspect, in which the attachment portion includes a clamping member, and the attachment portion is capable of clamping a part of the attached portion by the clamping member.

According to the present aspect, the attachment portion includes the clamping member. The attachment portion is capable of clamping a part of the attached portion by the clamping member. Accordingly, it is possible to further stabilize the attachment state in which the scanner unit is attached to the other member.

The image reading apparatus according to a sixteenth aspect of the present disclosure is an aspect dependent on the twelfth aspect, in which the attachment portion is drawable out from the scanner unit in accordance with a position of the attached portion.

The present aspect can also be dependent on the fifteenth aspect.

According to the present aspect, the attachment portion is drawable out from the scanner unit in accordance with the position of the attached portion. Accordingly, this makes it easy to cope with a difference in size or form of each of the attached portions of the other member. That is, the scanner unit can be attached by adjusting a drawing-out amount by which the attachment portion is drawn out according to a difference in size or form of each of the attached portions.

The image reading apparatus according to a seventeenth aspect of the present disclosure is an aspect dependent on the sixteenth aspect, in which the attachment portion is drawable out in an extending direction of the scanner unit or a direction intersecting the extending direction.

According to the present aspect, the attachment portion is drawable out in the extending direction of the scanner unit or the direction intersecting the extending direction, and thus the scanner unit can be attached according to the size or form of each of the attached portions.

### Embodiments

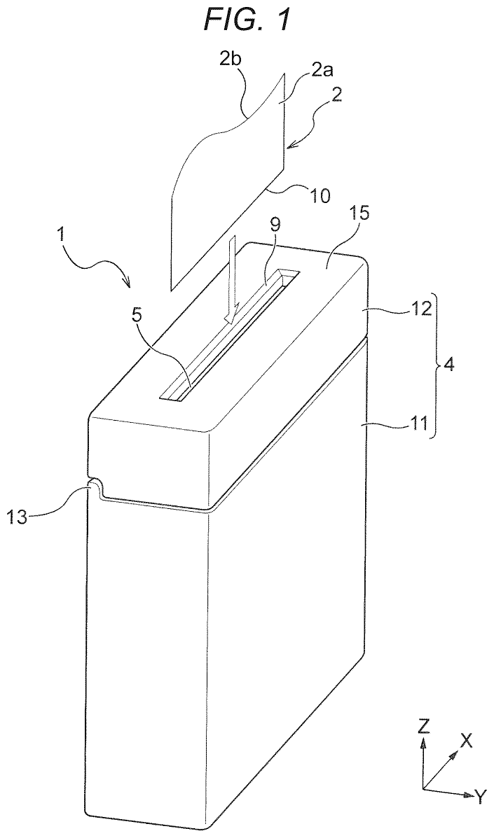

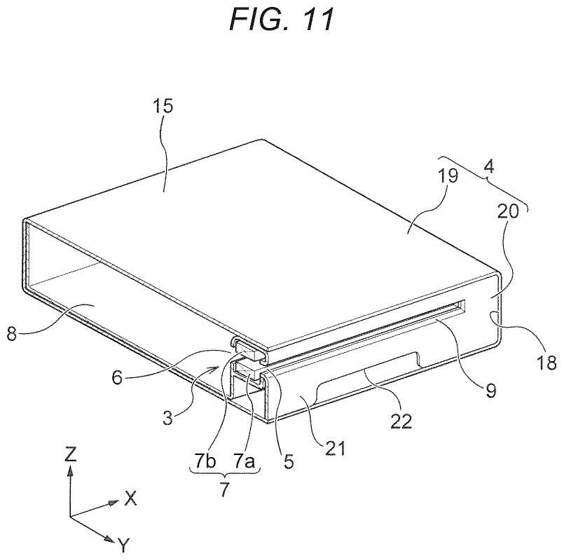

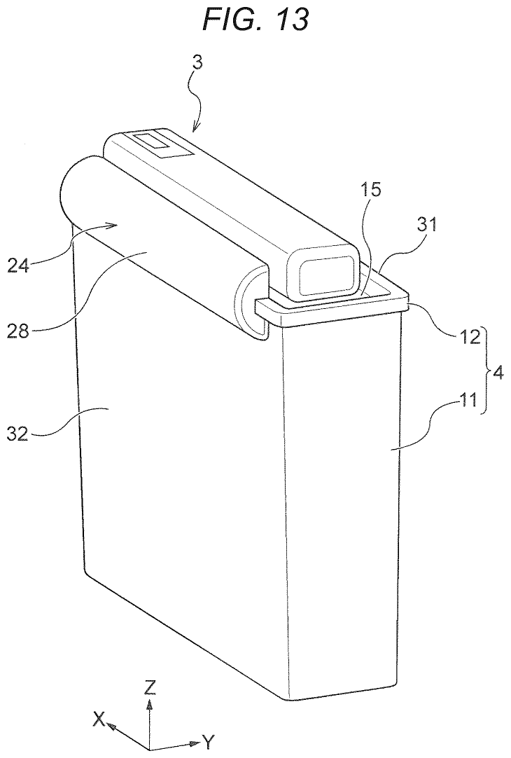

Hereinafter, an image reading apparatus according to an embodiment of the present disclosure will be specifically described with reference to FIGS. 1 to 26.

In the following explanation, three axes orthogonal to one another are respectively represented as an X axis, a Y axis, and a Z axis as illustrated in the figures. Directions indicated by arrows of the three axes (X, Y, and Z) are + directions, and the opposite directions thereof are − directions. The Z-axis direction is equivalent to the vertical direction, that is, a direction in which the gravity acts, the +Z direction indicates the vertically upward direction and the −Z direction indicates the vertically downward direction. The X-axis direction and the Y-axis direction correspond to a horizontal direction. A +Y direction indicates a front direction of the image reading apparatus, and a −Y direction indicates a rear direction of the image reading apparatus. A +X direction indicates a right direction of the image reading apparatus, and a −X direction indicates a left direction of the image reading apparatus.

The image reading apparatus 1 of the present embodiment is a scanner capable of reading an image on a medium 2. Here, the image refers to an image visually recorded on the medium 2, for example, a character, a figure, a table, a picture, and a photograph. The medium 2 is not limited to a sheet-shaped medium such as A4 paper or A3 paper, and includes a card, a booklet, and the like. The medium 2 is also referred to as a document.

### Embodiment 1

The image reading apparatus 1 according to Embodiment 1 will be described with reference to FIGS. 1 to 4. The image reading apparatus 1 according to Embodiment 1 includes a scanner unit 3 and a container 4.

The scanner unit 3 includes a receiving port 5 and a discharge port 6 for the medium 2, and a reading unit 7 that reads an image on the medium 2. The receiving port 5 is an inlet that receives the medium 2, and is opened upward (+Z direction) of the image reading apparatus 1. The reading unit 7 reads an image on the medium 2 received and conveyed from the receiving port 5. The discharge port 6 is an outlet that discharges the medium 2 that passes through an image reading region of the reading unit 7 to an outside of the scanner unit 3.

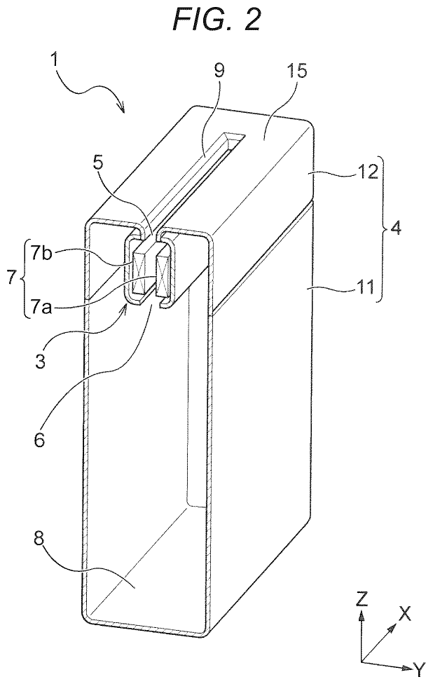

As illustrated in FIG. 2, the reading unit 7 (for example, a CIS or a CCD sensor) includes a first reading unit 7a that reads an image on a front surface 2a of the medium 2 and a second reading unit 7b that reads an image on a back surface 2b of the medium 2. That is, the reading unit 7 reads both the front surface 2a and the back surface 2b of the medium 2. The reading unit 7 may be capable of reading only one surface.

Here, elements other than the reading unit 7, the receiving port 5, and the discharge port 6 among elements of the scanner unit 3, for example, conveyance rollers are not illustrated from the viewpoint of avoiding complication of the drawing.

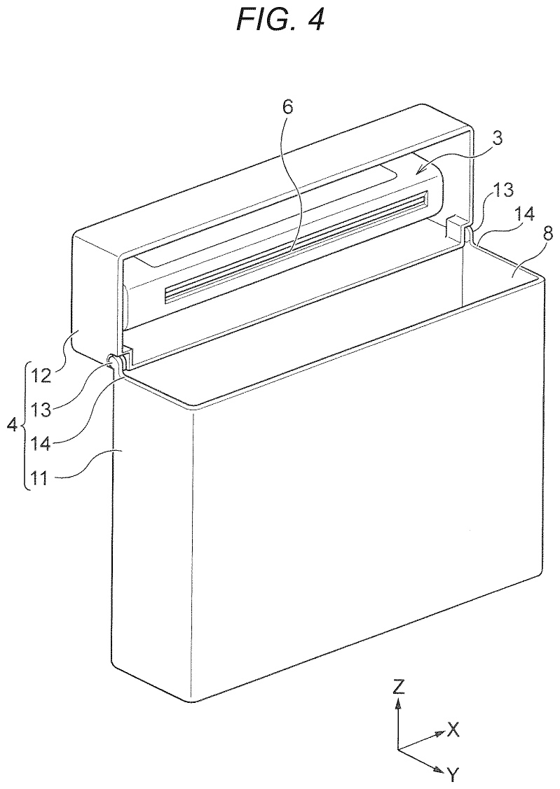

As illustrated in FIGS. 2 and 4, the scanner unit 3 is attached to the inside of the container 4. The container 4 includes an accommodation unit 8 that accommodates the medium 2 to be discharged from the discharge port 6 of the scanner unit 3, and an entry port 9 that allows the medium 2 to enter.

The entry port 9 is provided on an upper surface 15 of the container 4 and is opened upward (+Z direction). The entry port 9 is disposed at a position communicating with the receiving port 5 of the scanner unit 3. That is, a leading end 10 of the medium 2 is received by the receiving port 5 of the scanner unit 3 by causing the leading end 10 of the medium 2 to enter the entry port 9 of the container 4.

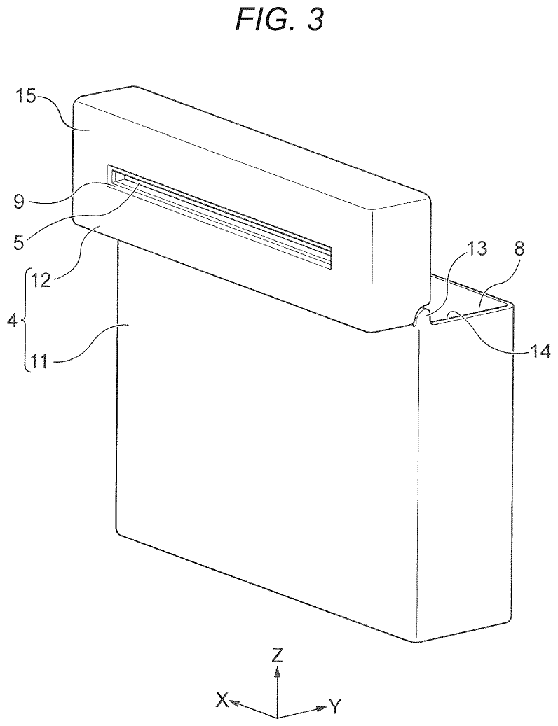

The scanner unit 3 is switchable between an exposed state (FIGS. 3 and 4) in which the scanner unit 3 is exposed to the outside of the container 4 and a non-exposed state (FIGS. 1 and 2) in which the scanner unit 3 is inside the container 4.

In the present embodiment, the container 4 includes a container main body 11 and a lid portion 12. The container main body 11 includes an accommodation unit 8. The lid portion 12 is capable of switching the accommodation unit 8 between an open state (FIGS. 3 and 4) and a closed state (FIGS. 1 and 2).

In the present embodiment, the lid portion 12 is attached to an opening edge 14 of the container main body 11 via a hinge 13. The lid portion 12 is switchable between the open state (FIGS. 3 and 4) and the closed state (FIGS. 1 and 2) by pivoting via the hinge 13.

As illustrated in FIGS. 2 and 4, the scanner unit 3 is attached to the inside of the lid portion 12. That is, the scanner unit 3 is fixed to the inside of the lid portion 12 by a fixing member (not illustrated) and is integrated with the lid portion 12. The entry port 9 is provided on the upper surface 15 of the lid portion 12, which is the upper surface 15 of the container 4. The scanner unit 3 is brought into the exposed state (FIGS. 3 and 4) by bringing the lid portion 12 into the open state (FIGS. 3 and 4) with respect to the container main body 11.

### Explanation of Operations of Embodiment 1

As illustrated in FIG. 1, when the leading end 10 of the medium 2 enters the entry port 9 downward from above the container 4, the leading end 10 of the medium 2 is received by the receiving port 5 of the scanner unit 3. The medium 2 is conveyed in the scanner unit 3 by the conveyance rollers (not illustrated), and an image is read when the medium 2 passes through the image reading region of the reading unit 7. The medium 2 whose image is read is discharged downward from the discharge port 6 and accommodated in the accommodation unit 8 of the container 4 in a vertical posture.

When the scanner unit 3 is maintained, the lid portion 12 is pivoted via the hinge 13 to be in the open state (FIGS. 3 and 4) with respect to the container main body 11. Accordingly, the scanner unit 3 is brought into the exposed state of being exposed to the outside of the container 4 (FIGS. 3 and 4), and can be accessed for maintenance.

In addition, the accommodation unit 8 of the container main body 11 is brought into the open state, and thus the medium 2 accommodated in the accommodation unit 8 can be picked up.

### Description of Effects of Embodiment 1

(1) In the present embodiment, the image reading apparatus 1 includes the scanner unit 3 that reads the image on the medium 2 received and conveyed from the receiving port 5, and the container 4 to which the scanner unit 3 is attached internally. Further, the container 4 includes the accommodation unit 8 that accommodates the medium 2 to be discharged from the scanner unit 3, and the entry port 9 that communicates with the receiving port 5 and allows the medium 2 to enter. Accordingly, as described above, the reading of the image on the medium 2 by the scanner unit 3 and the accommodating of the medium 2 after the reading can be performed in series at the same time, and the usability can be improved.

The scanner unit 3 is switchable between the exposed state in which the scanner unit 3 is exposed to the outside of the container 4 and the non-exposed state in which the scanner unit 3 is inside the container 4. Accordingly, by switching the scanner unit 3 to the exposed state, the access to the scanner unit 3 is facilitated, and the maintenance or the like is easily performed.
(2) In the present embodiment, the container 4 includes the lid portion 12 capable of switching the accommodation unit 8 between the open state and the closed state. The scanner unit 3 is attached to the lid portion 12. The entry port 9 is provided in the lid portion 12. Then, the scanner unit 3 is brought into the exposed state by bringing the lid portion 12 into the open state. Accordingly, the scanner unit 3 can be easily accessed by bringing the lid portion 12 into the open state.
(3) In the present embodiment, the lid portion 12 is attached to the container main body 11 so as to be openable and closable by pivoting. Accordingly, the lid portion 12 can be switched between the open state and the closed state with a simple structure, and thus the scanner unit 3 can be easily accessed.

### Modification 1 of Embodiment 1

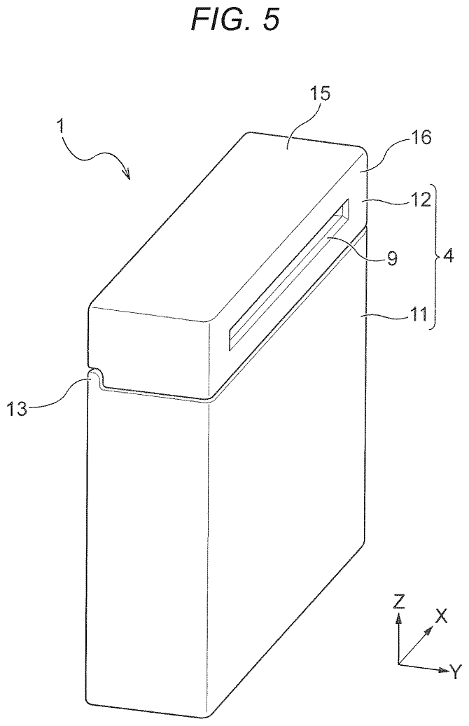

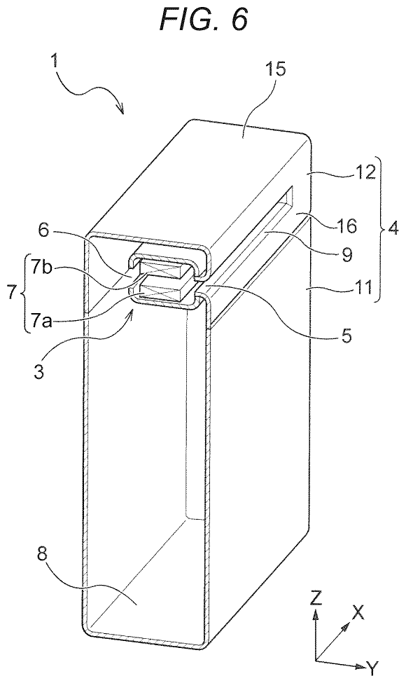

Modification 1 of Embodiment 1 will be described with reference to FIGS. 5 and 6. In Modification 1, the entry port 9 is disposed on a front surface 16 rather than on the upper surface 15 of the lid portion 12.

As illustrated in FIG. 6, the scanner unit 3 is disposed such that the receiving port 5 is opened toward a front surface 16 side (+Y direction) in accordance with the disposition of the entry port 9. In other words, when the scanner unit 3 is installed in the “vertical direction” in FIG. 1, the scanner unit 3 is installed in the “horizontal direction” in Modification 1.

The medium 2 enters from the entry port 9 in the horizontal direction, passes through the receiving port 5 and the image reading region of the reading unit 7, and is discharged from the discharge port 6. The medium 2 coming out of the discharge port 6 is guided downward by its own weight or by coming into contact with an inner surface of the container 4, falls into the accommodation unit 8, and is accommodated in the vertical posture.

Other structures and effects are the same as those of the embodiment in FIG. 1, and thus the description thereof will be omitted. In the structure of Modification 1, there is little possibility that a foreign matter falls inside from the entry port 9.

### Embodiment 2

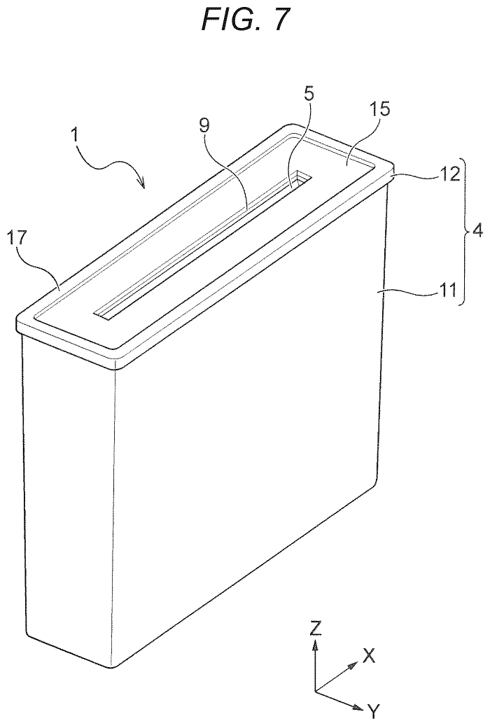

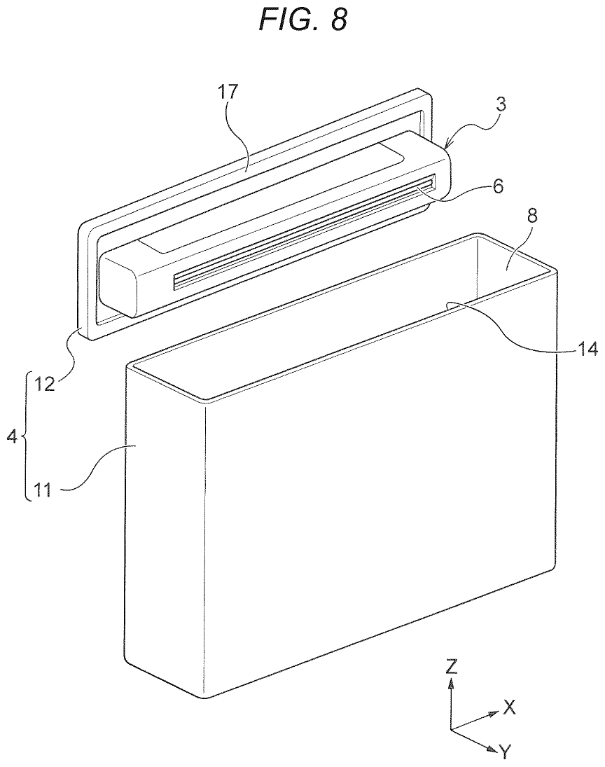

Next, the image reading apparatus 1 according to Embodiment 2 will be described with reference to FIGS. 7 and 8. The same portions as those of Embodiment 1 have the same signs, and the description of the configurations and the corresponding operations and effects thereof is omitted.

The image reading apparatus 1 according to Embodiment 2 is different from Embodiment 1 in that the lid portion 12 is detachably provided on the container main body 11. That is, instead of a pivot structure using the hinge 13, as illustrated in FIG. 8, the lid portion 12 can be detached from the container main body 11, thereby allowing switching between the open state (FIG. 8) and the closed state (FIG. 7). A grip portion 17 is provided around the entire peripheral edge portion of the lid portion 12. The lid portion 12 is mounted on the container main body 11 in a state in which a back surface of the upper surface 15 is placed on the opening edge 14 (FIG. 8) of the container main body 11, and the grip portion 17 surrounds the opening edge 14 from the outside. By gripping and lifting the grip portion 17 with a hand, as illustrated in FIG. 8, a user can detach from the container main body 11 to bring the accommodation unit 8 into the open state and bring the scanner unit 3 into the exposed state in which the scanner unit 3 is exposed to the outside of the container 4.

### Explanation of Effects of Embodiment 2

In the present embodiment, as described above, the lid portion 12 is detachably provided on the container main body 11. Accordingly, the scanner unit 3 can be easily accessed by detaching the lid portion 12 from the container main body 11. In addition, a maintenance work is easily performed by placing the grip portion 17 of the lid portion 12 on a workbench.

### Embodiment 3

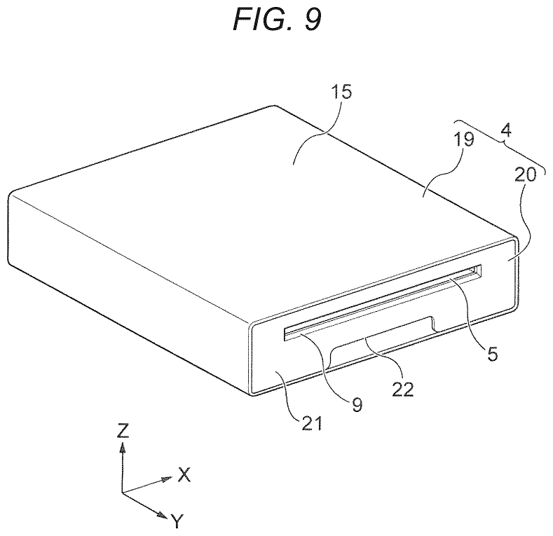

Next, the image reading apparatus 1 according to Embodiment 3 will be described with reference to FIGS. 9 to 11. The same portions as those of Embodiment 1 and the like have the same signs, and the description of the configurations and the corresponding operations and effects thereof is omitted.

In the image reading apparatus 1 according to Embodiment 3, the container 4 includes a case 19 having a drawing port 18, and a drawing portion 20. The drawing portion 20 includes the accommodation unit 8 and is accommodated in the case 19 so as to be drawable out. The scanner unit 3 is attached to an inside of an operation unit 21 that is operated by a hand or the like when the drawing portion 20 is drawn out. The operation unit 21 includes a handle portion 22. The user places a hand on the handle portion 22 of the drawing portion 20 and draws out the drawing portion 20 from the case 19.

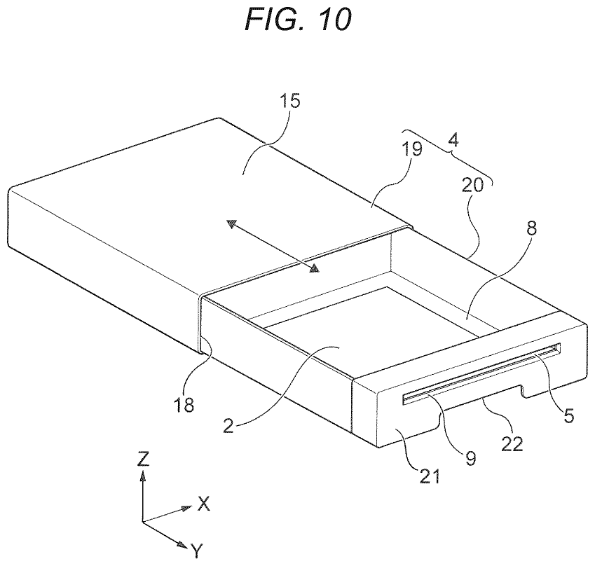

As illustrated in FIG. 10, the entry port 9 is provided on a front surface of the operation unit 21. The medium 2 entered from the entry port 9 is different from the state of being accommodated in the vertical posture in Embodiments 1 and 2 in that the medium 2 is discharged and accommodated in the accommodation unit 8 in a horizontal posture from the receiving port 5 through the discharge port 6.

### Explanation of Effects of Embodiment 3

According to the present embodiment, as described above, the container 4 includes the case 19 having the drawing port 18, and the drawing portion 20 having the accommodation unit 8 and accommodated in the case 19 so as to be drawable out. The scanner unit 3 is attached inside the operation unit 21 when the drawing portion 20 is drawn out. The entry port 9 is provided in the operation unit 21. Then, the scanner unit 3 is brought into the exposed state (FIG. 10) by drawing out the drawing portion 20 from the case 19. Accordingly, the scanner unit 3 can be easily accessed by drawing out the drawing portion 20 from the case 19.

The upper surface 15 of the case 19, which is the upper surface of the container 4, can be used as a place on which other objects are placed.

### Embodiment 4

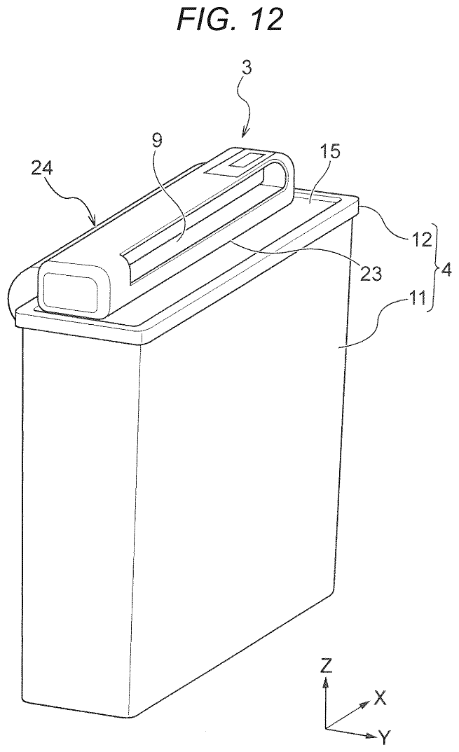

Next, the image reading apparatus 1 according to Embodiment 4 will be described with reference to FIGS. 12 to 14. The same portions as those of Embodiment 1 and the like have the same signs, and the description of the configurations and the corresponding operations and effects thereof is omitted.

The image reading apparatus 1 according to Embodiment 4 also includes the scanner unit 3 and the container 4. The scanner unit 3 has the receiving port 5 and the discharge port 6 for the medium 2, and reads an image on the medium 2 received and conveyed from the receiving port 5.

The container 4 includes the accommodation unit 8 that accommodates the medium 2. As in Embodiment 1, the container 4 includes the container main body 11 and the lid portion 12. The container 4 includes an installation location portion 23 in which the scanner unit 3 is installed on the upper surface 15 of the lid portion 12, which is the upper surface 15 of the container 4. The container 4 includes a guide path 24. The guide path 24 is fixed to the lid portion 12 of the container 4. The guide path 24 guides, to the accommodation unit 8, the medium 2 to be discharged from the discharge port 6 of the scanner unit 3 in a state where the scanner unit is installed in the installation portion 23.

In the present embodiment, the scanner unit 3 is detachably attached to the installation location portion 23. When the scanner unit 3 is installed in the installation location portion 23, the discharge port 6 is connected to an inlet 25 of the guide path 24. Specifically, the installation location portion 23 is provided with a positioning mark (not illustrated) for installing the scanner unit 3.

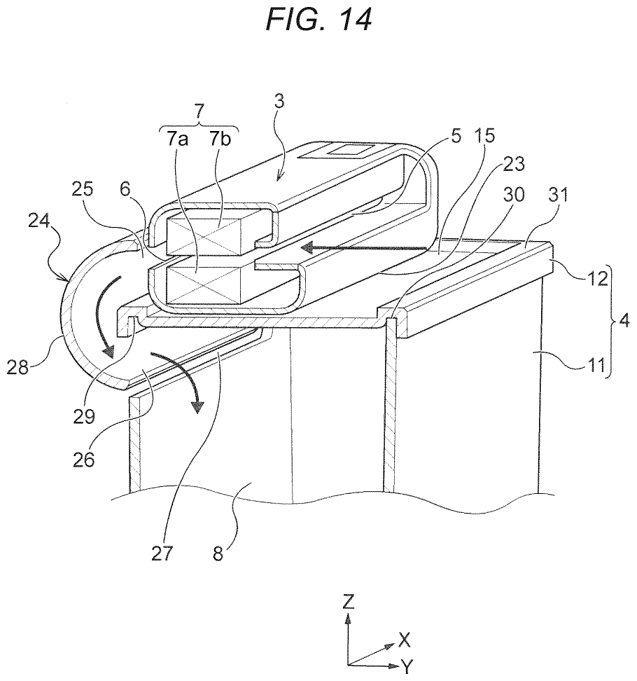

As illustrated in FIG. 14, the guide path 24 includes the inlet 25, a U-shaped flipping unit 28, and an outlet 26. The medium 2 to be discharged from the discharge port 6 of the scanner unit 3 enters the inlet 25 of the guide path 24, a traveling direction is flipped in a U shape by the U-shaped flipping unit 28, and the medium 2 falls into the accommodation unit 8 from the outlet 26. A container back surface 32 of the container main body 11 is provided with a communication hole 27 that communicates the outlet 26 with the inside of the accommodation unit 8.

In the present embodiment, a recessed groove 29 is formed around the entire periphery of the grip portion 31 of the lid portion 12. When the opening edge 30 of the container main body 11 is fitted into the recessed groove 29 of the grip portion 31 of the lid portion 12, the lid portion 12 is detachably mounted on the container main body 11.

In the present embodiment, the receiving port 5 receives the medium 2 from a direction (+Y direction) intersecting the vertical direction (Z-axis direction). The discharge port 6 is located on the rear side (−Y side) when the receiving port 5 is located on the front side (+Y side). That is, the guide path 24 is located on the container back surface 32.

### Explanation of Effects of Embodiment 4

(1) The image reading apparatus 1 according to the present embodiment includes the scanner unit 3 that reads the image on the medium 2 received and conveyed from the receiving port 5, and the container 4 including the accommodation unit 8 that accommodates the medium 2. The container 4 includes the installation location portion 23 in which the scanner unit 3 is installed on the upper surface 15, and the guide path 24 guides, to the accommodation unit 8, the medium 2 to be discharged from the discharge port 6 of the scanner unit 3 in a state where the scanner unit is installed in the installation portion 23.

Accordingly, the reading of the image on the medium 2 by the scanner unit 3 and the accommodating of the medium 2 after the reading can be performed in series at the same time via the guide path 24, and thus the usability is good. In addition, the scanner unit 3 is installed in the installation location portion 23 located on the upper surface 15 of the container 4, and thus the access to the scanner unit 3 is facilitated, and the maintenance or the like is easily performed.
(2) In the present embodiment, the scanner unit 3 is detachably attached to the installation location portion 23, and when the scanner unit 3 is installed in the installation location portion 23, the discharge port 6 is connected to the guide path 24. Accordingly, the scanner unit 3 can be detached from the container 4. In addition, when the scanner unit 3 is installed in the container 4, the installation can also be easily performed.
(3) In the present embodiment, the receiving port 5 is located on the front side, and a user inserts the medium 2 from the lateral direction rather than from above, and thus it is easy to use. In addition, there is little possibility that a foreign matter falls into the receiving port 5.

### Embodiment 5

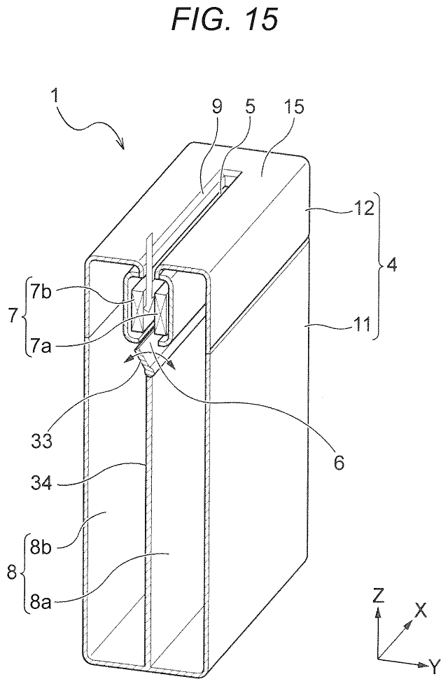

Next, the image reading apparatus 1 according to Embodiment 5 will be described with reference to FIG. 15. The same portions as those of Embodiment 1 and the like have the same signs, and the description of the configurations and the corresponding operations and effects thereof is omitted.

In the image reading apparatus 1 according to Embodiment 5, the container 4 includes the accommodation unit 8 divided into two units, the first accommodation unit 8a and the second accommodation unit 8b. The accommodation unit 8 may be divided into three or more units. The first accommodation unit 8a and the second accommodation unit 8b are partitioned by a partition wall 34.

The container 4 includes a switching unit 33 that switches the discharge destination of the medium 2 to be discharged from the discharge port 6 to the first accommodation unit 8a or the second accommodation unit 8b. The switching unit 33 is pivotably attached to an upper end portion of the partition wall 34. When the switching unit 33 pivots, the discharge destination of the medium 2 is switched to the first accommodation unit 8a or the second accommodation unit 8b. The switching unit 33 may be manually switchable or may be switchable using a drive source such as a motor. The switching unit 33 is also referred to as a flap.

### Explanation of Effects of Embodiment 5

In the present embodiment, the container 4 can switch the discharge destination of the medium 2 to be discharged from the discharge port 6 to the first accommodation unit 8a or the second accommodation unit 8b by the switching unit 33. Accordingly, the medium 2 can be accommodated separately for each type of the medium 2, and handling of the storage of the medium 2 is facilitated.

### Embodiment 6

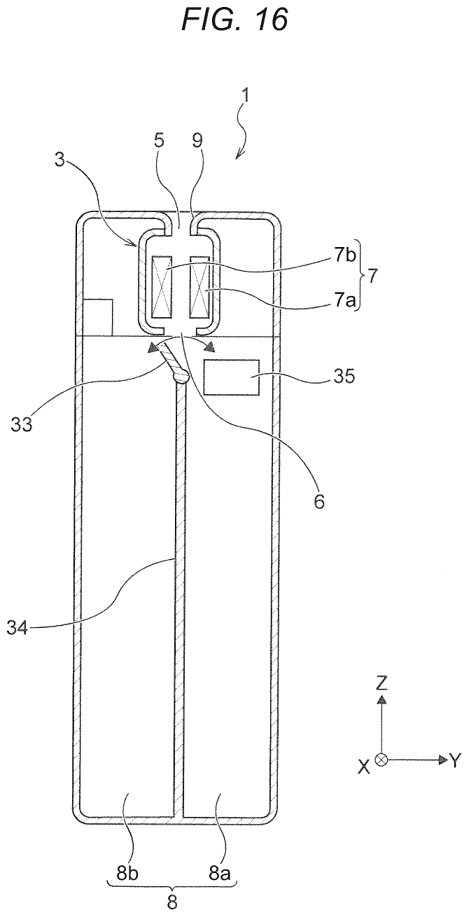

Next, the image reading apparatus 1 according to Embodiment 6 will be described with reference to FIG. 16. The same portions as those of Embodiment 1 and the like have the same signs, and the description of the configurations and the corresponding operations and effects thereof is omitted.

The image reading apparatus 1 according to Embodiment 6 includes a shredder 35 that shreds the medium 2. The shredder 35 is disposed downstream of the discharge port 6 in the discharge direction of the medium 2. In the present embodiment, the shredder 35 is disposed at an inlet of the first accommodation unit 8a. Accordingly, the medium 2 to be discharged into the first accommodation unit 8a via the switching unit 33 is shredded by the shredder 35 and accommodated. On the other hand, the medium 2 to be discharged into the second accommodation unit 8b is accommodated as it is without being shredded.

The shredder 35 may be disposed in both the first accommodation unit 8a and the second accommodation unit 8b. In addition, a single shredder 35 may be disposed in a single accommodation unit 8.

### Explanation of Effects of Embodiment 6

In the present embodiment, the image reading apparatus 1 includes the shredder 35 that shreds the medium 2 disposed downstream of the discharge port 6 in the discharge direction of the medium 2. Accordingly, when the medium 2 is to be discarded after the image is read, the medium 2 can be easily discarded by the shredder 35.

### Embodiment 7

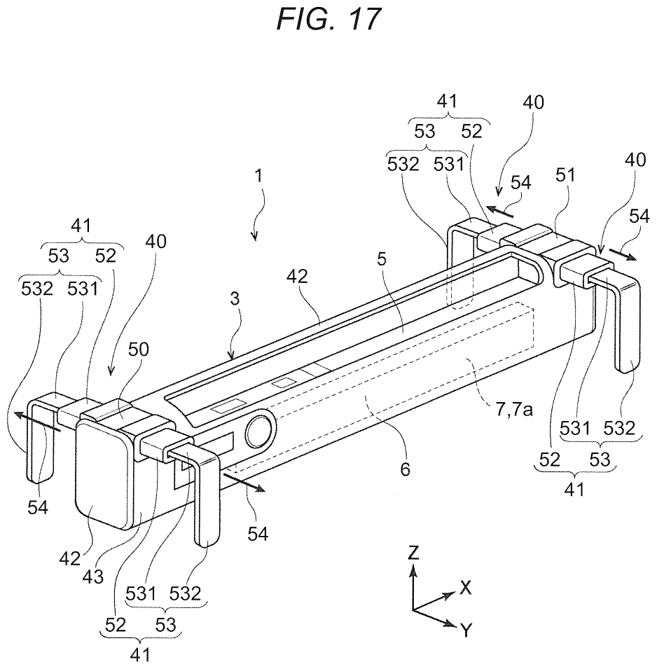

The image reading apparatus 1 according to Embodiment 7 will be described with reference to FIGS. 17 to 21. The image reading apparatus 1 according to Embodiment 7 includes the scanner unit 3 and an attachment portion 40.

The scanner unit 3 includes a receiving port 5 and a discharge port 6 for the medium 2, and a reading unit 7 that reads an image on the medium 2. The receiving port 5 is an inlet that receives the medium 2, and is opened upward (+Z direction) of the image reading apparatus 1. The reading unit 7 reads an image on the medium 2 received and conveyed from the receiving port 5. The discharge port 6 is an outlet that discharges the medium 2 that passes through an image reading region of the reading unit 7 to an outside of the scanner unit 3.

Here, the reading unit 7 includes a contact type image sensor module of a CIS type or a CCD type. The reading unit 7 includes the first reading unit 7a that reads an image on the front surface 2a of the medium 2 and the second reading unit (not illustrated) that reads an image on the back surface 2b of the medium 2. That is, the reading unit 7 reads both the front surface 2a and the back surface 2b of the medium 2. The reading unit 7 may be capable of reading only one surface.

Here, elements other than the reading unit 7, the receiving port 5, and the discharge port 6 among elements of the scanner unit 3, for example, conveyance rollers are not illustrated from the viewpoint of avoiding complication of the drawing.

As illustrated in FIG. 17, in the present embodiment, the attachment portion 40 is installed in an installation through-hole 55 located in an upper portion of a main body 42 of the scanner unit 3. The attachment portions 40 are provided in pairs on a front side (+Y side) and a rear side (−Y side) of the scanner unit 3.

The attachment portion 40 includes an L-shaped hook member 41. The hook members 41 are installed in the installation through-hole 55 located at both end portions 50 and 51 in the extending direction (X-axis direction) of the scanner unit 3.

The hook member 41 includes a holder 52 and an L-shaped portion 53. The holder 52 is accommodated in the installation through-hole 55 so as to be drawable out in a drawing direction 54 (Y-axis direction).

Here, the L-shaped portion 53 includes a first portion 531 in the horizontal direction and a second portion 532 in the vertical direction. The L-shaped portion 53 is provided such that the first portion 531 can be drawn out in the drawing direction 54 (Y-axis direction) in the holder 52. That is, the attachment portion 40 is provided in the scanner unit 3 so as to be drawable out, and the drawing direction 54 is a direction (Y-axis direction) intersecting the extending direction (X-axis direction) of the scanner unit 3.

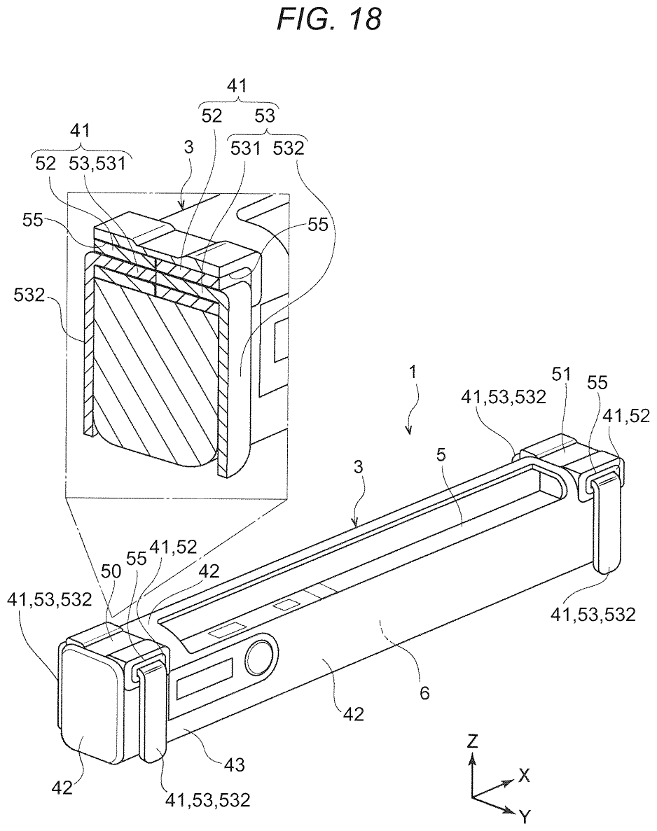

FIG. 17 illustrates a state in which all the four attachment portions 40 are drawn out in the drawing direction 54. FIG. 18 illustrates a state in which the attachment portions 40 are returned in a direction opposite to the drawing direction 54. As illustrated in FIG. 18, in the returned state, the entire holder 52 enters the inside of the installation through-hole 55 and is not exposed to the outside. As illustrated in the enlarged cross-sectional view in FIG. 18, a pair of holders 52 move to a position at which they come into contact with each other inside the installation through-hole 55 and stop at the contact position.

The L-shaped portion 53 is also configured such that the first portion 531 moves inside the holder 52 that moves inside the installation through-hole 55, moves to a position at which a pair of first portions 531 come into contact with each other, and stops at the contact position. In this state, the second portion 532 of the L-shaped portion 53 is in contact with a side surface 43 of the main body 42, thereby implementing a compact size.

The first portion 531 and the second portion 532 of the L-shaped portion 53 are pulled against each other by a built-in spring (not illustrated). That is, the first portion 531 and the second portion 532 receive a returning force in a direction opposite to the drawing direction 54.

When changing from the state of FIG. 18 to the state of FIG. 17, the holder 52 is stopped by a retaining mechanism (not illustrated) before the entire length in the drawing direction 54 is drawn out.

The L-shaped portion 53 is also stopped by a retaining mechanism (not illustrated) before the entire length of the first portion 531 is drawn out from the stopped holder 52 against a returning force of the built-in spring.

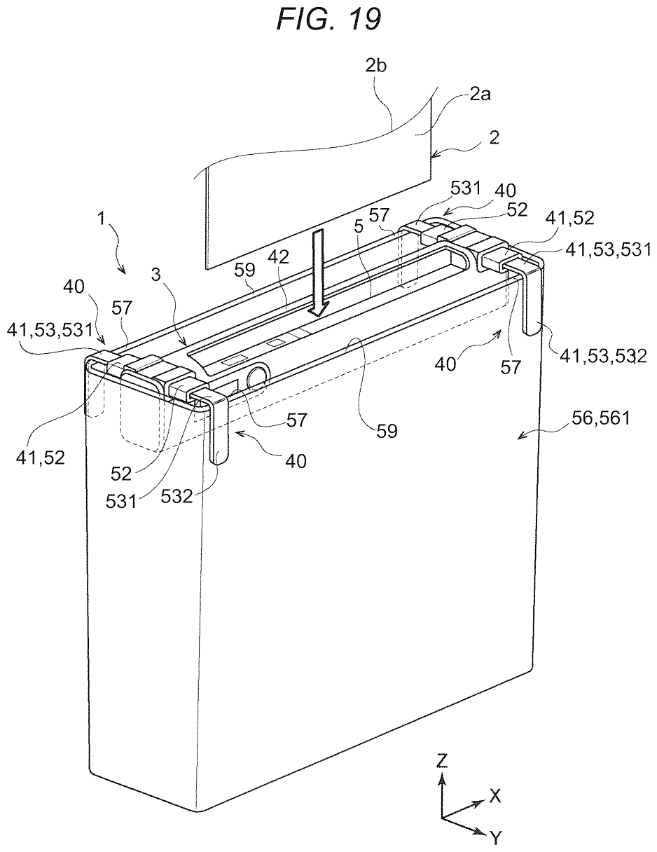

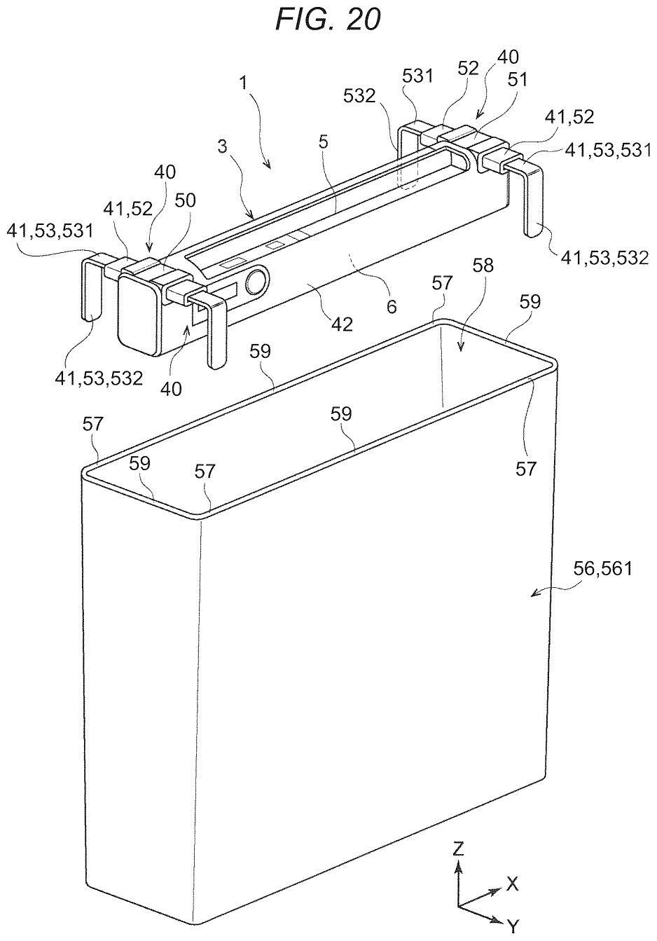

As illustrated in FIGS. 19 and 20, the scanner unit 3 is attachable to the attached portion 57 of the other member 56 by the attachment portion 40. In the present embodiment, the other member 56 is a container 561. The container 561 is a bottomed rectangular parallelepiped box having an opening 58 at an upper portion. A peripheral edge portion 59 that forms the opening 58 of the container 561 is used as the attached portion 57. In a state in which the scanner unit 3 is attached to the container 561, the scanner unit 3 is located in the container 561 except for a part of the upper portion of the main body 42. Therefore, the scanner unit 3 is protected from the surroundings by the container 561, and there is little possibility of damage due to an inadvertent impact or the like.

The container 561 receives the medium 2 to be discharged from the discharge port 6 of the scanner unit 3 and accommodates the medium 2 therein. As illustrated in FIG. 20, the opening 58 is opened by detaching the scanner unit 3 from the container 561, and thus the medium 2 in the container 561 can be picked up.

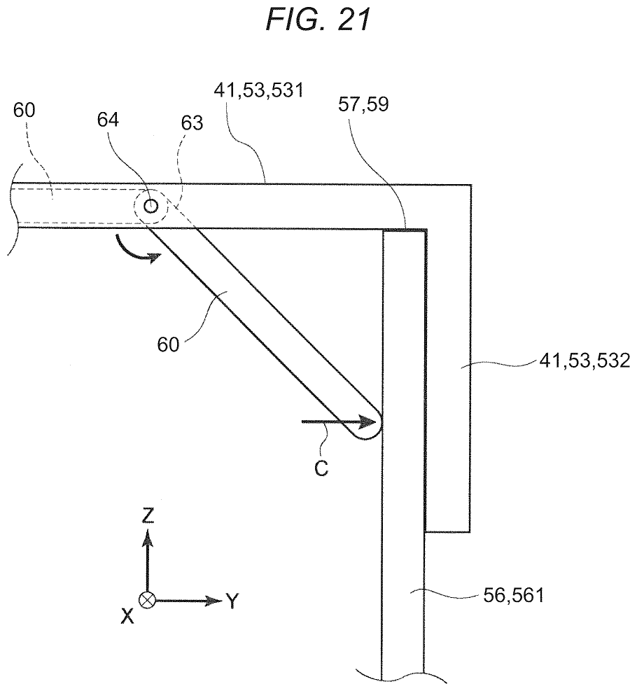

As illustrated in FIG. 21, in the present embodiment, the attachment portion 40 includes a clamping member 60. The attachment portion 40 is capable of clamping a part of the attached portion 57 of the other member 56 by the clamping member 60.

Here, the clamping member 60 is attached to the first portion 531 of the L-shaped portion 53. As indicated by a broken line in FIG. 21, the clamping member 60 is within a thickness of the first portion 531 of the L-shaped portion 53 when not used. The base portion 63 of the clamping member 60 is pivotably provided on a shaft 64 fixed to the first portion 531.

The clamping member 60 applies a clamping force C to the attached portion 57 by a torsion coil spring (not illustrated). When the clamping member 60 is within the thickness of the first portion 531 of the L-shaped portion 53, the clamping member 60 is held by a holding portion (not illustrated) so as not to be pivoted by an elastic force of the torsion coil spring. When the holding by the holding portion is released, the clamping member 60 is pivoted by the elastic force and enters the clamping state illustrated in FIG. 21. The clamping member 60 can return to a position indicated by the broken line in FIG. 21 by being pivoted clockwise in FIG. 21 against the elastic force.

The attached portion 57 of the other member 56 is clamped between the second portion 532 and the clamping member 60 in a state in which the clamping force C is applied by the clamping member 60. Accordingly, a strong attachment state by the attachment portion 40 is implemented.

The clamping member 60 is not limited to the above structure. Any structure may be used as long as the strong attachment state by the attachment portion 40 can be implemented, and for example, a clamping structure of a clothespin may be used.

In the above description, the case in which the other member 56 is the container 561 has been described, but a case in which the scanner unit 3 is attached to the other member 56 different from the container 561 will be described below.

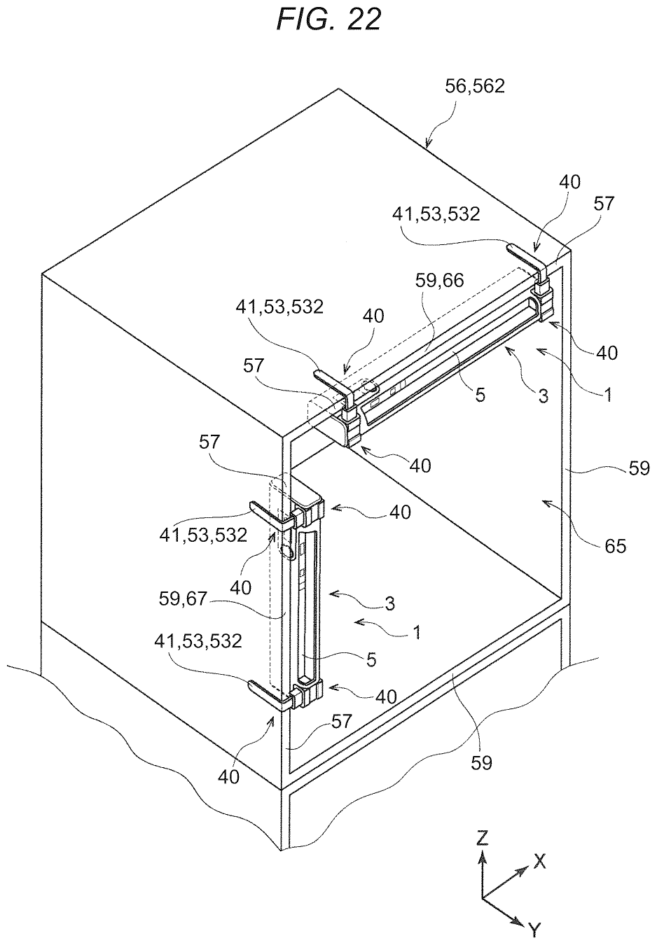

FIG. 22 illustrates a state in which the scanner unit 3 is attached to an accommodation box 562 instead of the container 561 as the other member 56. A front surface of the accommodation box 562 is opened as an accommodation port 65. The peripheral edge portion 59 that forms the accommodation port 65 is used as the attached portion 57.

Specifically, as illustrated in FIG. 22, the scanner unit 3 can be attached to an upper side portion 66 by the attachment portion 40 by using the upper side portion 66 of the peripheral edge portion 59 of the accommodation box 562 as the attached portion 57.

Further, as illustrated in FIG. 22, the scanner unit 3 can also be attached to a left side portion 67 by the attachment portion 40 by using the left side portion 67 of the peripheral edge portion 59 of the accommodation box 562 as the attached portion 57.

### Explanation of Operations of Embodiment 7

As illustrated in FIG. 20, the hook member 41 as the attachment portion 40 is drawn out in the drawing direction 54 in accordance with the position of the attached portion 57 of the container 561 as the other member 56. In the drawn state, the scanner unit 3 is attached to the container 561 to be in the state of FIG. 19. In this state, the scanner unit 3 is located in the container 561 except for a part of the upper portion of the main body 42. That is, the scanner unit 3 is protected from the surroundings by the container 561.

When the medium 2 is inserted into the receiving port 5 of the scanner unit 3, the image on the medium 2 is read by the reading unit 7 and is discharged from the discharge port 6 into the container 561. As illustrated in FIG. 20, the medium 2 discharged into the container 561 can be picked up from the container 561 by detaching the scanner unit 3 from the container 561.

### Explanation of Effects of Embodiment 7

(1) In the present embodiment, the scanner unit 3 is provided with the attachment portion 40. Then, the scanner unit 3 is attachable to the attached portion 57 of the other member 56 by the attachment portion 40. Accordingly, the attachment to one or more other members 56 having different sizes or shapes via the attachment portion 40 becomes possible, which increases the variation of usage, and improves the usability.
(2) In the present embodiment, the attachment portion 40 is the hook member 41. Accordingly, it is possible to perform the attachment in a state of being hooked on the attached portion 57 of the other member 56, and thus, for example, the attachment as illustrated in FIG. 19 or the attachment as illustrated in FIG. 22 is possible, and the usability is good. In addition, the scanner unit 3 can be stably attached to the other member 56. In addition, a compact design can be achieved for the attachment portion 40.
(3) In the present embodiment, the attachment portion 40 includes the clamping member 60. The attachment portion 40 is capable of clamping a part of the attached portion 57 by the clamping member 60. Accordingly, it is possible to further stabilize the attachment state in which the scanner unit 3 is attached to the other member 56.
(4) In the present embodiment, the attachment portion 40 is drawable out from the scanner unit 3 in accordance with the position of the attached portion 57. Accordingly, this makes it easy to cope with a difference in size or form of each of the attached portions 57 of the other member 56. That is, the scanner unit 3 can be attached by adjusting a drawing-out amount by which the attachment portion 40 is drawn out according to the difference in size or form of each of the attached portions 57.
(5) In the present embodiment, the attachment portion 40 can be drawn out in the direction (Y-axis direction) intersecting the extending direction (X-axis direction) of the scanner unit 3, and thus the scanner unit 3 can be attached according to the size or form of each of the attached portions 57.

### Embodiment 8

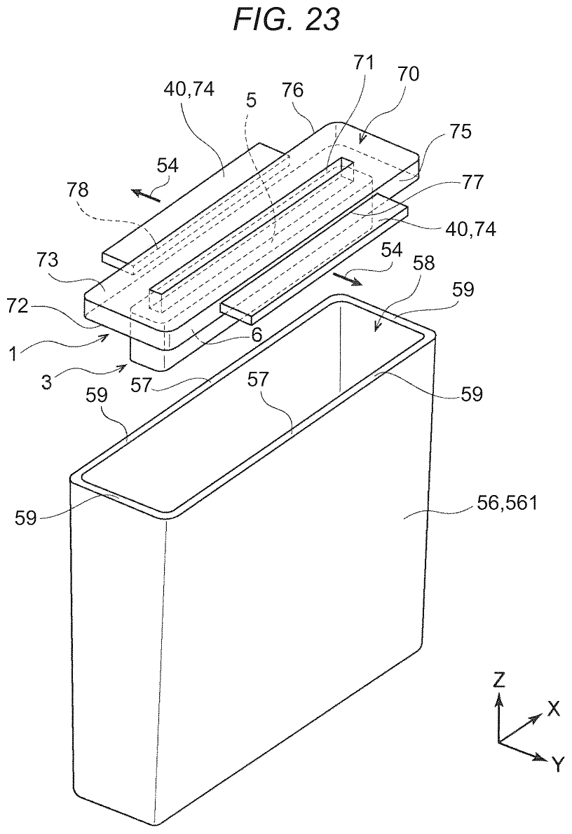

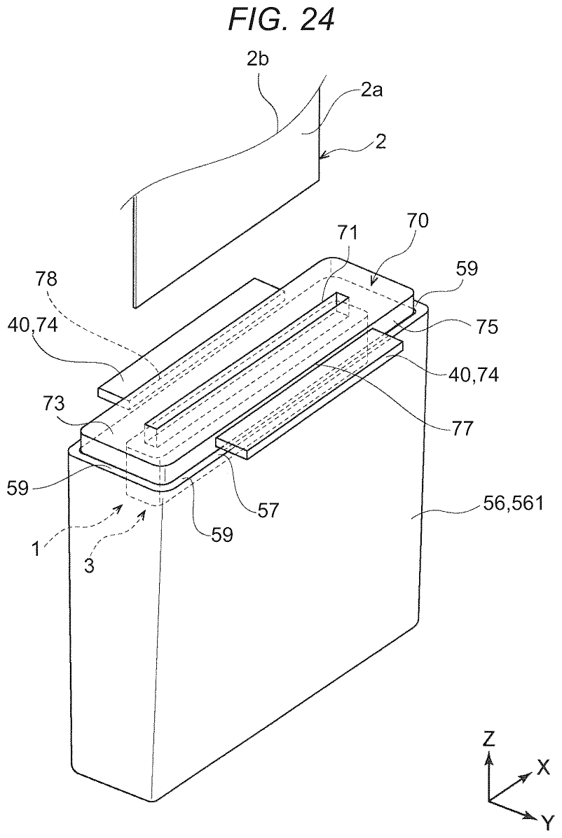

Next, the image reading apparatus 1 according to Embodiment 8 will be described with reference to FIGS. 23 and 24. The same portions as those of Embodiment 7 have the same signs, and the description of the configurations and the corresponding operations and effects thereof is omitted.

The image reading apparatus 1 according to Embodiment 8 includes a base member 70 to which the scanner unit 3 is attached. The base member 70 is formed in a rectangular plate shape. The base member 70 has a size slightly smaller than that of the opening 58 of the container 561. The base member 70 includes an entry port 71 that communicates with the receiving port 5 and allows the medium 2 to enter.

That is, the scanner unit 3 is fixed to a lower surface 72 of the base member 70. There is only the entry port 71 on an upper surface 73 of the base member 70. Then, the attachment portion 40 is provided on the base member 70.

In the present embodiment, the attachment portion 40 is implemented by a rectangular flat plate 74. The flat plates 74 are provided on a front side (+Y side) 75 and a rear side (−Y side) 76 of the base member 70, respectively.

The flat plates 74 are provided in insertion ports 77 and 78 formed in the respective sides 75 and 76 so as to be drawable out in the drawing direction 54. A drawing-out amount of the flat plate 74 can be adjusted in accordance with the position of the attached portion 57 of the container 561, which is the other member 56.

FIG. 24 illustrates a state in which the scanner unit 3 is attached to the attached portion 57 of the container 561 via the flat plates 74, which are the attachment portions 40. In this state, a part of a lower portion of the scanner unit 3, that is, a portion located below a lower surface of the flat plate 74 is located below a position of the peripheral edge portion 59 of the container 561. Accordingly, the attachment state is stabilized.

In the present embodiment, the image reading apparatus 1 includes the base member 70 to which the scanner unit 3 is attached, and the attachment portions 40 are provided on the base member 70. Accordingly, the scanner unit 3 is in a state of being attached to the other member 56 via the base member 70, and thus the stability of the attached state is good.

The base member 70 includes the entry port 71 that communicates with the receiving port 5 and allows the medium 2 to enter. Accordingly, in a state in which the scanner unit 3 is attached to, for example, the container 561, the scanner unit 3 is surrounded by the container 561 and the base member 70. That is, there is little possibility of damage due to an inadvertent impact or the like.

### Embodiment 9

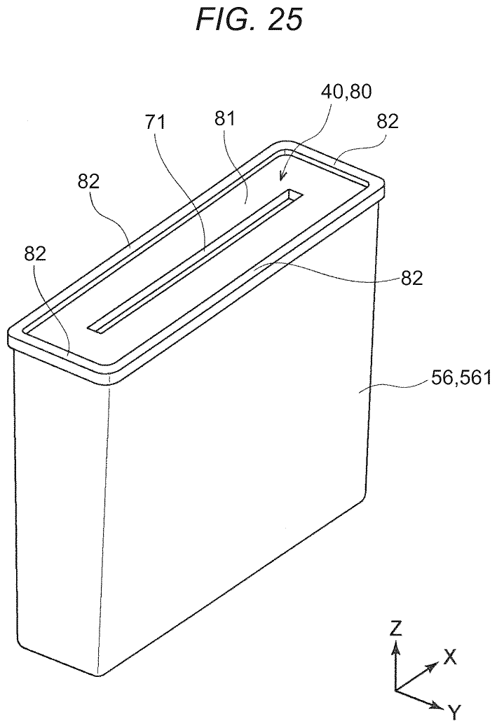

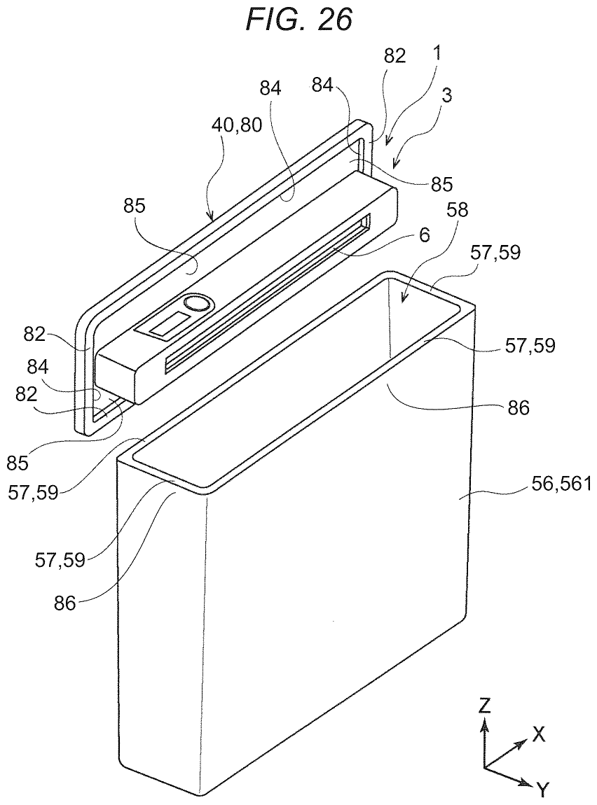

Next, the image reading apparatus 1 according to Embodiment 9 will be described with reference to FIGS. 25 and 26. The same portions as those of Embodiment 7 or 8 have the same signs, and the description of the configurations and the corresponding operations and effects thereof is omitted.

In the image reading apparatus 1 of Embodiment 9, the other member 56 is the container 561 that can accommodate the medium 2 to be discharged from the discharge port 6 and has the opening 58. The attached portion 57 is the peripheral edge portion 59 that forms the opening 58. The attachment portion 40 is a lid 80 that closes the opening 58. Then, the lid 80 includes the scanner unit 3 attached thereto and the entry port 71 that communicates with the receiving port 5 and allows the medium 2 to enter.

As illustrated in FIGS. 25 and 26, here, the lid 80 has a substantially rectangular shape. The lid 80 includes an opening closing portion 81 on a flat plate having the entry port 71, and a frame body 82 provided on the entire circumference of an outer peripheral portion of the opening closing portion 81. The frame body 82 has a thickness larger than that of the opening closing portion 81. In a state in which the lid 80 covers the opening 58 of the container 561 (FIG. 25), an inner surface 85 of the opening closing portion 81 is in contact with the peripheral edge portion 59 of the container 561, and an inner peripheral surface 84 of the frame body 82 is in contact with an outer peripheral surface 86 of an upper portion of the container 561. That is, in the state in which the lid 80 covers the opening 58 of the container 561, the lid 80 is designed to have almost no rattle.

In the present embodiment, the other member 56 is the container 561 that can accommodate the medium 2 to be discharged from the discharge port 6 and has the opening 58. The attached portion 57 is the peripheral edge portion 59 that forms the opening 58. The attachment portion 40 is a lid 80 that closes the opening 58. Further, the lid 80 includes the scanner unit 3 attached thereto and the entry port 71 that communicates with the receiving port 5 and allows the medium 2 to enter.

Accordingly, when the scanner unit 3 is attached to the container 561, it is covered with the lid 80. Therefore, the scanner unit 3 is in a protected state without being exposed to the outside, and it is possible to reduce the possibility of damage due to an inadvertent impact or the like.

### Other Embodiments

The image reading apparatus 1 according to the present disclosure is based on the configuration of the embodiment described above, and it is needless to say that the partial configuration can be changed or omitted without departing from the gist of the present disclosure.

In Embodiment 4, it has been described that the container 4 includes the lid portion 12 and the container main body 11, and the lid portion 12 is detachably attached to the container main body 11. However, the container 4 may have a structure in which the lid portion 12 is not detachably attached to the container main body 11, but is integrated with the container main body 11. The integrated structure can also be handled by providing a pick-up port for picking up the medium 2 accommodated in the accommodation unit 8 in the container 4.

The container 4 has a structure in which a light-transmissive member that allows the accommodation unit 8 to be visually recognized is partially disposed, whereby an accommodation state of the accommodation unit 8 can be easily visually recognized.

In Embodiments 7 and 8, it has been described that the hook member 41 is installed at both end portions 50 and 51 in the extending direction (X-axis direction) of the scanner unit 3. However, the present disclosure is not limited thereto, and the hook member 41 may be installed at both end portions in the direction (Y-axis direction) intersecting the extending direction (X-axis direction) of the scanner unit 3. In this case, the drawing direction 54 is the extending direction (X-axis direction) of the scanner unit 3.

In Embodiments 7 and 8, the attachment portion 40 may be detachably attached to the scanner unit 3. That is, the scanner unit 3 may be attached to other different attachment portions in a switching manner.

What is claimed is:

1. An image reading apparatus comprising:
a scanner unit having a receiving port and a discharge port for a medium and configured to read an image on the medium received and conveyed from the receiving port; and
a container to which the scanner unit is to be attached internally, wherein
the container includes
an accommodation unit that accommodates the medium to be discharged from the scanner unit, and
an entry port that communicates with the receiving port and allows the medium to enter, and
the scanner unit is switchable between an exposed state in which the scanner unit is exposed to an outside of the container and a non-exposed state in which the scanner unit is inside the container.

2. The image reading apparatus according to claim 1, wherein
the container includes
a container main body including the accommodation unit, and
a lid portion provided on the container main body so as to be capable of switching the accommodation unit between an open state and a closed state,
the scanner unit is attached to the lid portion,
the entry port is provided in the lid portion, and
the scanner unit is brought into the exposed state by bringing the lid portion into the open state.

3. The image reading apparatus according to claim 2, wherein
the lid portion is attached to the container main body so as to be openable and closable by pivoting.

4. The image reading apparatus according to claim 2, wherein
the lid portion is detachably provided on the container main body.

5. The image reading apparatus according to claim 1, wherein
the container includes
a case having a drawing port, and
a drawing portion including the accommodation unit and accommodated in the case so as to be drawable out,
the scanner unit is attached to an inside of an operation unit when the drawing portion is drawn out,
the entry port is provided in the operation unit, and
the scanner unit is brought into the exposed state by drawing out the drawing portion from the case.

6. An image reading apparatus comprising:
a scanner unit having a receiving port and a discharge port for a medium and configured to read an image on the medium received and conveyed from the receiving port; and
a container including an accommodation unit configured to accommodate the medium, wherein
the container includes
an installation location portion on an upper surface thereof, the scanner unit being installed in the installation location portion, and
a guide path that guides, to the accommodation unit, the medium to be discharged from the discharge port of the scanner unit in a state where the scanner unit is installed in the installation portion.

7. The image reading apparatus according to claim 6, wherein
the scanner unit is detachably attached to the installation location portion, and
when the scanner unit is installed in the installation location portion, the discharge port is connected to the guide path.

8. The image reading apparatus according to claim 6, wherein
the receiving port receives the medium from a direction intersecting a vertical direction,
the discharge port is located on a rear side when the receiving port is located on a front side, and
the guide path is located on the rear side.

9. The image reading apparatus according to claim 1, wherein
the container includes
two or more accommodation units including a first accommodation unit and a second accommodation unit as the accommodation units, and
a switching unit that switches a discharge destination of the medium to be discharged from the discharge port to each of the two or more accommodation units.

10. The image reading apparatus according to claim 1, further comprising:
a shredder configured to shred the medium downstream of the discharge port in a discharge direction of the medium.

11. An image reading apparatus comprising:
a scanner unit having a receiving port and a discharge port for a medium, and configured to read an image on the medium received and conveyed from the receiving port and discharge the medium from the discharge port; and
an attachment portion provided on the scanner unit, wherein
the scanner unit is attachable to an attached portion of another member by the attachment portion.

12. The image reading apparatus according to claim 11, wherein
the attachment portion is a hook member, and
the hook member is installed at both end portions in an extending direction of the scanner unit or both end portions in a direction intersecting the extending direction.

13. The image reading apparatus according to claim 11, further comprising:
a base member to which the scanner unit is to be attached, wherein
the base member includes an entry port that communicates with the receiving port and allows the medium to enter, and
the attachment portion is provided on the base member.

14. The image reading apparatus according to claim 11, wherein
the other member is a container having an opening and being capable of accommodating the medium to be discharged from the discharge port,
the attached portion is a peripheral edge portion that forms the opening,
the attachment portion is a lid that closes the opening, and
the lid includes the scanner unit attached thereto and an entry port that communicates with the receiving port and allows the medium to enter.

15. The image reading apparatus according to claim 11, wherein
the attachment portion includes a clamping member, and
the attachment portion is capable of clamping a part of the attached portion by the clamping member.

16. The image reading apparatus according to claim 12, wherein
the attachment portion is drawable out from the scanner unit in accordance with a position of the attached portion.

17. The image reading apparatus according to claim 16, wherein
the attachment portion is drawable out in an extending direction of the scanner unit or a direction intersecting the extending direction.
